(19) United States
(12) Patent Application Publication
(10) Pub. No.: US 2010/0049665 A1
(43) Pub. Date: Feb. 25, 2010

(54) BASEL ADAPTIVE SEGMENTATION HEURISTICS

(76) Inventors: CHRISTOPHER ALLAN RALPH, Toronto (CA); Michael S. Sossi, San Francisco, CA (US); Gary J. Sullivan, San Francisco, CA (US)

Correspondence Address: MINTZ, LEVIN, COHN, FERRIS, GLOVSKY AND POPEO, P.C, ONE FINANCIAL CENTER, BOSTON, MA, 02111, US

(21) Appl. No.: 12/430,806

(22) Filed: Apr. 27, 2009

Related U.S. Application Data
(60) Provisional application No. 61/048,155, filed on Apr. 25, 2008.

(51) Int. Cl. G06Q 40/00

(52) U.S. Cl. 705/36 R

(57) ABSTRACT

A system and method for identifying homogeneous risk pools used in the calculation of minimum capital requirements for a number of segments of a population of portfolios is presented. An F-ratio objective function representing a probability of a risk event across all of the number of segments of the population is calculated using an F-ratio objective function engine. An input dataset that defines a decision tree structure for the population is received. The F-ratio objective function of the risk event is maximized using a generic algorithm-based search engine to optimize the decision tree structure to group the number of segments according to one or more of the homogeneous risk pools, and a score for each homogeneous risk pool is then generated.

### CROSS REFERENCE TO RELATED APPLICATIONS

This application claims the benefit of priority under 35 U.S.C. §119 to U.S. Provisional Patent Application Ser. No. 61/048,155, filed on Apr. 25, 2008, entitled, “BASEL ADAPTIVE SEGMENTATION HEURISTICS”, the entire disclosures of which is incorporated by reference herein.

### BACKGROUND

Basel Adaptive Segmentation Heuristics, or “BASH,” is a tree search tool used to segment lending portfolios onto homogenous risk pools for calculating minimum capital requirements under the Basel II Accord. The Basel II Accord is a document put together by the Bank for International Settlements (or BIS), based in Basel, Switzerland, that outlines capitalization standards for financial institutions to ensure sufficient loan loss provisions are available to offset default risks.

From a retail banking perspective, one of the requirements outlined in the Accord is the identification of “homogeneous risk pools”, containing groups of similar accounts with similar levels of risk. The process of coming up with the best possible pools is extremely complex, rife with possible error, and time consuming. Under the Accord, lenders need to define “risk pools”, or client segments, as part of the input to the calculation of capital, where there's a homogeneous level of risk within each pool but the average risk of each pool is very different. The better homogeneous risk pools are identified with different probabilities of default, the lower the minimum capital a lender needs to set aside. Further, different pooling methodologies can generate massive differences in how much capital the banks need to set aside for loan losses, which in some cases can be a difference of hundreds of millions of dollars.

Conventional applications for complying with the Accord do not use a genetic algorithm to find a decision tree by maximizing the F-ratio of a continuous variable. Accordingly, what is needed is an adaptive segmentation heuristics application and system that can adequately address this problem, and save lenders capital needed to be set aside for loan losses.

### SUMMARY

In general, this document discusses a system and method for segmenting lending portfolios onto homogenous risk pools for calculating minimum capital requirements under the Basel II Accord.

In accordance with one implementation, a system to identify homogeneous risk pools used in the calculation of minimum capital requirements for a number of segments of a population of portfolios is disclosed. The system includes a portfolio segmentation tool comprising an F-ratio objective function engine to calculate an F-ratio objective function representing a probability of a risk event across all of the number of segments of the population, and a genetic algorithm-based search engine. The genetic algorithm-based search engine receives an input dataset that defines a decision tree structure for the population, maximizes the F-ratio objective function of the risk event to optimize the decision tree structure to group the number of segments according to one or more of the homogeneous risk pools, and generates a score for each homogeneous risk pool.

In accordance with another implementation, a method for identifying homogeneous risk pools used in the calculation of minimum capital requirements for a number of segments of a population of portfolios is disclosed. The method includes calculating an F-ratio objective function representing a probability of a risk event across all of the number of segments of the population using an F-ratio objective function engine, and receiving an input dataset that defines a decision tree structure for the population. The method further includes maximizing the F-ratio objective function of the risk event using a genetic algorithm-based search engine to optimize the decision tree structure to group the number of segments according to one or more of the homogeneous risk pools. The method further includes generating a score for each homogeneous risk pool.

The details of one or more embodiments are set forth in the accompanying drawings and the description below. Other features and advantages will be apparent from the description and drawings, and from the claims.

### BRIEF DESCRIPTION OF THE DRAWINGS

These and other aspects will now be described in detail with reference to the following drawings.

FIG. 1 is a flowchart of a tree splitting method for use with a BASH system and method.

FIG. 2 depicts an exemplary BASH system and computer architecture.

FIG. 3 shows an example BASH system interface.

FIG. 4 illustrates a BASH system and method output.

Like reference symbols in the various drawings indicate like elements.

### DETAILED DESCRIPTION

This document describes a Basel Adaptive Segmentation Heuristics (BASH) system and method, which uses a portfolio segmentation tool to identify homogeneous risk pools used in the calculation of minimum capital requirements under the Basel II Accord (“Basel II”). In accordance with an exemplary implementation, the BASH system includes a genetic algorithm-based search engine, and an F-ratio objective function engine. The BASH system and methods are particularly suitable for finding homogeneous pools that are part of the compliance requirements outlined in Basel II.

The BASH system is a tree search tool that identifies homogeneous pools of accounts in retail lending portfolios for calculating loan loss provisions under the Basel II Accord. The pools provide the basis for both the calculation of minimum capital as well as portfolio stress testing, and are a key point of focus for regulators. Pools may be created for any of the three key component measures under Basel II (PD, EAD, and LGD), where the distribution of the chosen measure should be relatively tight within the pools, while the variance of the mean values across the pools should be high.

In BASH, the pools are defined by the tree logic corresponding to leaf nodes. The BASH search process is driven by a genetic algorithm engine that maximizes the F-ratio of the chosen component performance measure. The F-ratio is a standard statistic from a single-factor analysis of variance (ANOVA), whose value grows when either within-group mean-variance decreases, or when across-group mean-variance increases. This statistic best aligns with the expectations of Basel regulators, which is why it was selected to govern the pool search process in BASH.

In addition to this Basel-specific objective function, the presently disclosed BASH system utilizes genetic algorithm (GA) driven search process. A GA is a computer-implemented search technique and evolutionary algorithm, in which a population of abstract representations of candidate solution groups to a problem evolves toward better solutions. Rather than an acquisitive, hierarchical search process that makes splitting decisions one at a time on progressively smaller subsets of the data, a GA evolves populations of fully formed trees using an objective function that measures the “fitness” of the entire tree. This global optimization approach enables the BASH system to avoid local maxima that often plagues traditional approaches. In fact, GAs can generate effective solutions to difficult problems (such as problems with non-differentiable, or even non-continuous fitness functions) that simply cannot be addressed with more traditional tree-search tools. Another key benefit of GAs is flexible encoding. Since they utilize a random population-based search process, GAs can be configured to address a very wide range of combinatorial optimization problems.

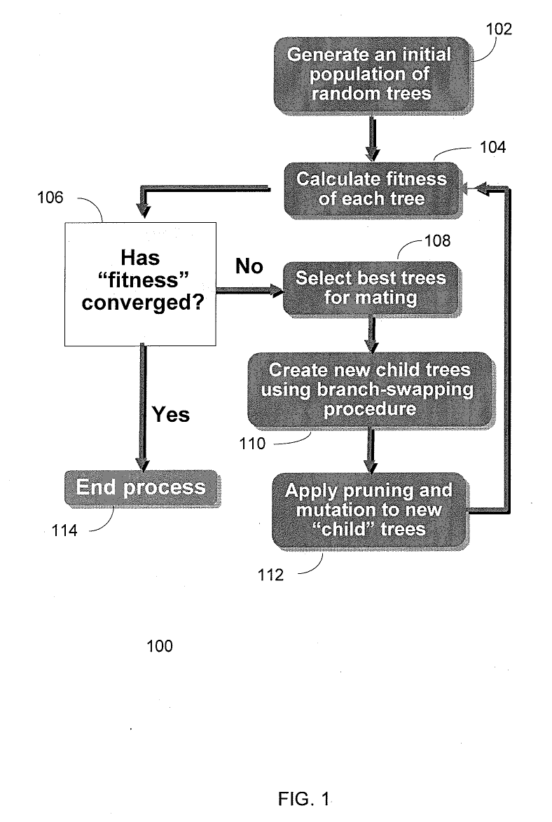

FIG. 1 is a flowchart of a process 100 for evolving trees using a GA in a BASH system. At 102, an initial population of COMPLETE trees is randomly generated by picking splitters and split points from a pre-defined list. Next, at 104, solutions for each tree are built in the current generation. Those solutions can be simple or complex, depending on the underlying business problem, but the only real criteria is that they must have a quantifiable fitness value that gets associated with each tree. At that point the GA takes over and determines whether the fitness of each tree converged, at 106. This step uses the concept of “survival of the fittest” by first picking pairs of “parent” trees, i.e. the best trees for mating at 108, swapping branches between them at 110 to create new “child” trees at 112, and then continuing through this loop until the predictive power of the population converges at 106 on a holdout sample to end the process at 114.

Once again, the GA enables evolution of the parameters, which are the individual splitters and split points, but survival is determined by a examining the fitness of the entire tree. This is different from almost any other tree building algorithm, which typically just use information in the current node to decide whether or not to split that node. Rather than use those kinds of highly localized decisions, the BASH system evolves this population of trees, and over time the best overall combination of splitters and split point emerges from this population.

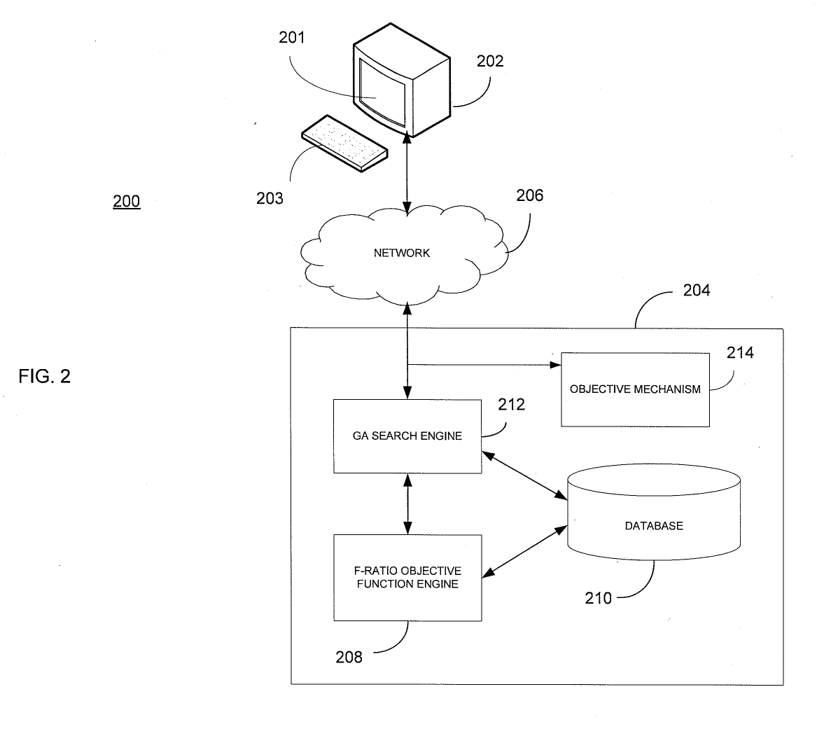

FIG. 2 depicts an exemplary BASH system 200 that executes a BASH program for using a portfolio segmentation tool to identify homogeneous risk pools used in the calculation of minimum capital requirements under the Basel II Accord. The BASH system 200 preferably runs on a single computing system or machine, but may also be implemented in a distributed computing environment. One implementation of a distributed computing environment includes a client system 202 coupled to a portfolio segmentation tool 204 through a network 206 (e.g., the Internet or an intranet). The client system 202 and portfolio segmentation tool 204 may be implemented as one or more processors, such as a computer, a server, a blade, and the like. Further, the BASH system 200 may be implemented on two or more client systems 202 that collaboratively communicate through the network 206.

The portfolio segmentation tool 204 includes a database 210 that stores portfolio data of a large number of borrowers associated with one or more lenders. The database 210 includes storage media that stores the data, which data can be structured as a relational database or structured according to a metamodel. The data base 210 can also include Basel II default data such as compliance requirements, that form the basis of the inputs to and outputs of the BASH system 200. The portfolio segmentation tool 204 further includes an F-ratio objective function engine 208 for generating and executing an F-ratio as described further below. The F-ratio objective function engine 208 is configured to calculate a probability of default (or other targets, such as default balance) calculated across segments of a population. A search engine 212 is configured to maximize the F-ratio to identify homogeneous risk pools based on the F-ratio. Accordingly, the portfolio segmentation tool 204 uses the F-ratio to identify the homogenous pools of loans.

In addition to maximizing the F-ratio of a chosen Basel II performance measure, the BASH system also includes an objective mechanism 214 to create user-defined objective functions. This means the analyst can use information from the input dataset to calculate tree-level fitness using any arbitrarily complex function that the BASH system will attempt to maximize by finding the best tree.

The portfolio segmentation tool 204 can be implemented on a server. Alternatively, the portfolio segmentation tool can be implemented on a local client computer as an application program stored on a local memory and executed by a local general purpose processor. Further still, the portfolio segmentation tool 204 can be implemented as a distributed application accessible by a number of the client systems 202 via a network. Each client system 202 includes an output device 201 such as a computer display for displaying a graphical representation of an output of the BASH system, and an input device 203 for receiving user input and instruction commands from a user.

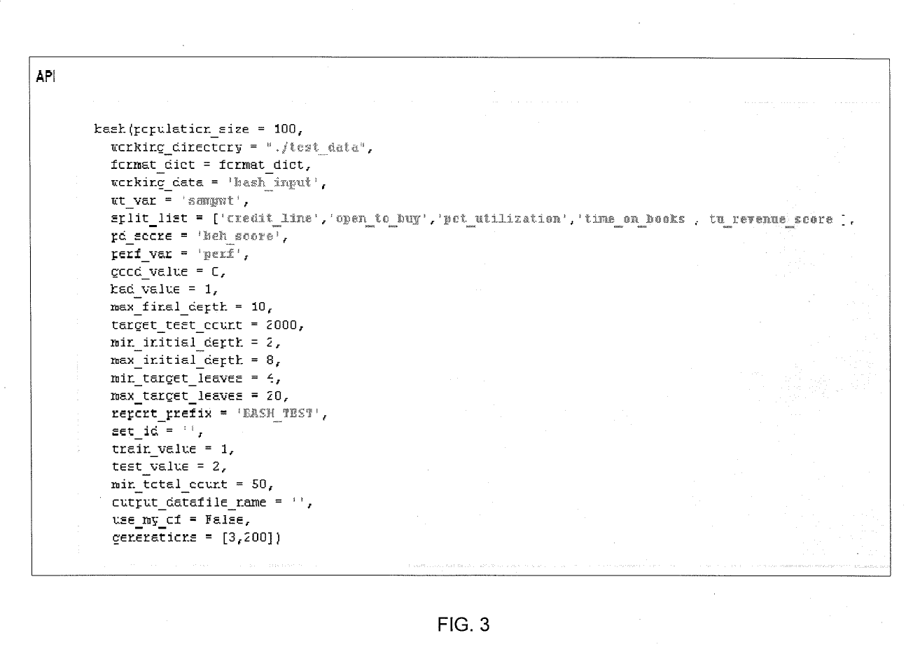

FIG. 3 illustrates an exemplary script-based interface for display on a computer display, showing a list of parameters that a user would enter to execute a BASH method. The main parameters are an input dataset, a list of the splitters desired to be searched through, information about how those splitters are binned, the Probability of Default (PD) score, a binary performance variable containing the actual Basel II default information, and sample weight.

The rest of the parameters can be included for functions such as controlling the tree size and depth, defining how the holdout sample gets defined, defining the values of “goods” and “bads” in the performance column, naming information for the outputs, and one or more parameters to control the basics of the genetic algorithm search. In the specific exemplary implementation shown in FIG. 3, the parameters may include a ‘use_my_of’ parameter if the analyst wants to come up with their own objective function instead of using the internal function.

The BASH objective function is the F-ratio of probability of default (or other targets, such as default balance) calculated across the segments. The F-Ratio is taken from a single factor ANOVA, and is the objective function that the tree search process is trying to maximize. In the BASH system, the F-ratio is equal to an across-segment mean variance of PD, divided by a within-segment mean variance of PD. In mathematical terms, the F-ratio can be defined as:

$$F = \frac{{\hat{σ}}_{across}^{2}}{{\hat{σ}}_{within}^{2}} = \frac{{SS}_{across} / d {f}_{across}}{{SS}_{within} / d {f}_{within}} = \frac{{\sum }_{i} {ω}_{i} \cdot {( {\overline{\hat{p}}}_{g} - \overline{\hat{p}} )}^{2} / G - 1}{{\sum }_{i} {ω}_{i} \cdot {( {\hat{p}}_{i} - {\overline{\hat{p}}}_{g} )}^{2} / N - G}$$

$$where N = {\sum }_{i} {ω}_{i}$$

This equation aligns solidly with the definition of “homogeneous risk pools” in the Basel II Accord.

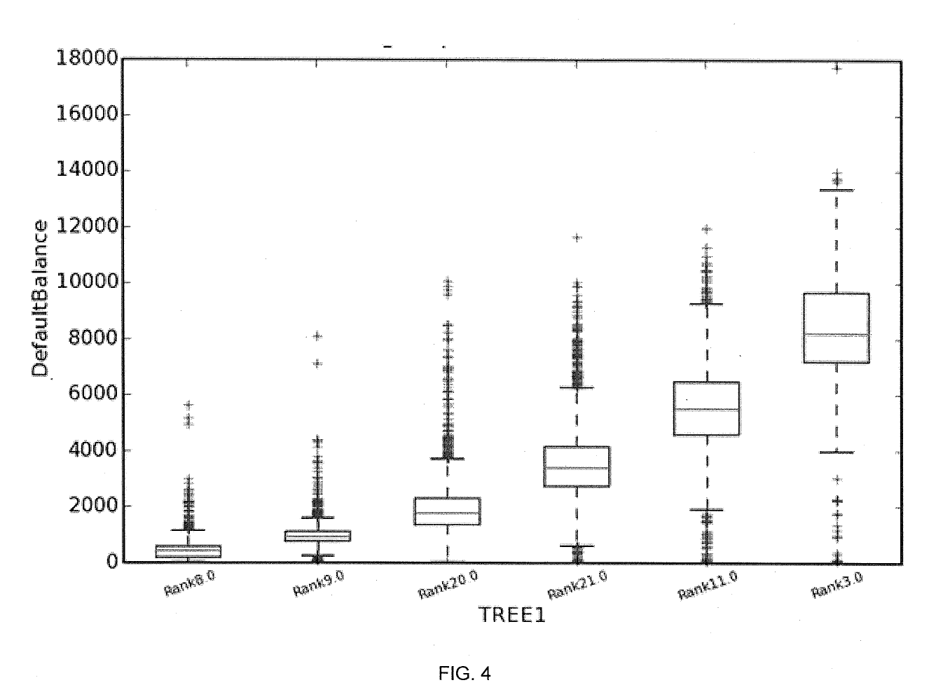

Outputs include tree logic reports, the tree pseudo code and ten scoring scripts, along with a series of generated scoring scripts that make it really easy to replicate the segments on a new set of data. The output also includes a series of box plots describing the distribution of the target across the leaf node segments, as shown in FIG. 4. Using this type of output, the BASH system can be used to find pools that were homogeneous with respect to default balance, also known as Exposure At Default (EAD) in the Accord. Along the x-axis are the segments that are equivalent to the leaves of the tree, and the boxes show the distribution of EAD across the segments. The F-ratio grows whenever distribution within the segments decreases, or when the distribution across the segments increases, as is shown in FIG. 4.

Upon completion of a run, the BASH system can generate Model Builder-style pseudo code that can be digitally transferred into a custom activity interface and used to generate the segments on new data.

Some or all of the functional operations and/or systems described in this specification can be implemented in digital electronic circuitry, or in computer software, firmware, or hardware, including the structures disclosed in this specification and their structural equivalents, or in combinations of them. Embodiments of the invention can be implemented as one or more computer program products, i.e., one or more modules of computer program instructions encoded on a computer readable medium, e.g., a machine readable storage device, a machine readable storage medium, a memory device, or a machine-readable propagated signal, for execution by, or to control the operation of, data processing apparatus.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of them. A propagated signal is an artificially generated signal, e.g., a machine-generated electrical, optical, or electromagnetic signal, that is generated to encode information for transmission to suitable receiver apparatus.

A computer program (also referred to as a program, software, an application, a software application, a script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to, a communication interface to receive data from or transfer data to, or both, one or more mass storage devices for storing data, e.g., magnetic, magneto optical disks, or optical disks.

Moreover, a computer can be embedded in another device, e.g., a mobile telephone, a personal digital assistant (PDA), a mobile audio player, a Global Positioning System (GPS) receiver, to name just a few. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

Certain features which, for clarity, are described in this specification in the context of separate embodiments, may also be provided in combination in a single embodiment. Conversely, various features which, for brevity, are described in the context of a single embodiment, may also be provided in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Particular embodiments of the invention have been described. Other embodiments are within the scope of the following claims. For example, the steps recited in the claims can be performed in a different order and still achieve desirable results. In addition, embodiments of the invention are not limited to database architectures that are relational; for example, the invention can be implemented to provide indexing and archiving methods and systems for databases built on models other than the relational model, e.g., navigational databases or object oriented databases, and for databases having records with complex attribute structures, e.g., object oriented programming objects or markup language documents. The processes described may be implemented by applications specifically performing archiving and retrieval functions or embedded within other applications.

1. A system to identify homogeneous risk pools used in the calculation of minimum capital requirements for a number of segments of a population of portfolios, the system comprising:
a portfolio segmentation tool comprising:
an F-ratio objective function engine to calculate an F-ratio objective function representing a probability of a risk event across all of the number of segments of the population; and
a genetic algorithm-based search engine that receives an input dataset that defines a decision tree structure for the population, maximizes the F-ratio objective function of the risk event to optimize the decision tree structure to group the number of segments according to one or more of the homogeneous risk pools, and generates a score for each homogeneous risk pool.

2. The system in accordance with claim 1, further comprising a client computer that hosts the portfolio segmentation tool.

3. The system in accordance with claim 1, wherein the client computer includes an input device for receiving the input dataset, and a display for graphically displaying a representation of the score for each homogeneous risk pool.

4. The system in accordance with claim 1, wherein the F-ratio objective function represents an across-segment mean variance of the probability of the risk event, divided by a within-segment mean variance of the probability of the risk event.

5. The system in accordance with claim 1, wherein the probability of the risk event includes a probability of default of a portfolio.

6. The system in accordance with claim 1, further comprising:
a server system that hosts the portfolio segmentation tool; and
one or more client computers that access the portfolio segmentation tool via a communications network, each client computer including an input device for receiving the input dataset, and a display for graphically displaying a representation of the score for each homogeneous risk pool.

7. A method for identifying homogeneous risk pools used in the calculation of minimum capital requirements for a number of segments of a population of portfolios, the method comprising:
calculating an F-ratio objective function representing a probability of a risk event across all of the number of segments of the population using an F-ratio objective function engine;
receiving an input dataset that defines a decision tree structure for the population;
maximizing the F-ratio objective function of the risk event using a genetic algorithm-based search engine to optimize the decision tree structure to group the number of segments according to one or more of the homogeneous risk pools; and
generating a score for each homogeneous risk pool.

8. The method in accordance with claim 7, further comprising generating a graphical representation of the score.

9. The method in accordance with claim 7, wherein the F-ratio objective function represents an across-segment mean variance of the probability of the risk event, divided by a within-segment mean variance of the probability of the risk event.

10. The system in accordance with claim 7, wherein the probability of the risk event includes a probability of default of a portfolio.
